(19) United States
(12) Patent Application Publication
(10) Pub. No.: US 2024/0185572 A1
(43) Pub. Date: Jun. 6, 2024

(54) SYSTEMS AND METHODS FOR JOINT OPTIMIZATION TRAINING AND ENCODER SIDE DOWNSAMPLING

(71) Applicant: OP Solutions, LLC, Amherst, MA (US)

(72) Inventors: Hari Kalva, BOCA RATON, FL (US); Borivoje Furht, BOCA RATON, FL (US); Velibor Adzic, CANTON, GA (US)

(21) Appl. No.: 18/440,517

(22) Filed: Feb. 13, 2024

Related U.S. Application Data
(63) Continuation of application No. PCT/US22/40722, filed on Aug. 18, 2022.
(60) Provisional application No. 63/235,438, filed on Aug. 20, 2021.
(60) Provisional application No. 63/235,552, filed on Aug. 20, 2021.

(51) Int. Cl. G06V 10/77; G06T 3/4046; G06V 10/82

(52) U.S. Cl. CPC G06V 10/7715; G06T 3/4046; G06V 10/82

(57) ABSTRACT

A method of joint optimization-training, the method comprising identifying, by a feature extractor, an input feature, generating, by the feature extractor, a feature map for the input feature, wherein generating the feature map further comprises receiving an initial parameter set, instantiating a loss function representing a feature representation precision and an encoding complexity level as a function of the input feature and the initial parameter set, and generating the feature map that minimizes the loss function, and transmitting, by the feature extractor, the feature map to an encoder.

### CROSS-REFERENCE TO RELATED APPLICATIONS

This application is a continuation of copending international application PCT/US22/40722, filed on Aug. 18, 2022 and entitled SYSTEMS AND METHODS FOR JOINT OPTIMIZATION TRAINING AND ENCODER SIDE DOWNSAMPLING, which application claims the benefit of priority to U.S. Provisional Application Ser. No. 63/235,438, filed on Aug. 20, 2021, and entitled SYSTEMS AND METHODS FOR DUAL-PURPOSE ENCODER-SIDE PREPROCESSING and also claims the benefit of priority to U.S. Provisional Application Ser. No. 63/235,552, filed on Aug. 20, 2021, and entitled SYSTEMS AND METHODS FOR JOINT OPTIMIZATION TRAINING, the disclosures of which are hereby incorporated by reference in their entireties.

### FIELD OF THE DISCLOSURE

The present disclosure generally relates to the field of video encoding and decoding. In particular, the present disclosure is directed to systems and methods for organizing and searching a video database.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, case of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

A system and method for joint optimization-training is provided, wherein the system includes a feature extractor. The feature extractor is preferably configured to identify an input feature and generate a feature map for the input feature. Generating the feature map may further comprise receiving an initial parameter set, instantiating a loss function representing a feature representation precision and an encoding complexity level as a function of the input feature and the initial parameter set. The system and method may generate the feature map such that the loss function is minimized and transmit the feature map to an encoder.

In some embodiments the process of identifying the input feature further comprises receiving an input video and may further comprise determining a relevant feature, such as by receiving an input training set that correlates a plurality of input features to a plurality of relevant features and determining the relevant feature as a function of the input feature using a machine learning model, wherein the machine learning model is trained as a function of the input training set. The machine learning model may include a convolutional neural network and/or a deep neural network.

The loss function may be configured to reduce a bitstream size and/or enhance the feature representation precision.

An encoder for dual-purpose encoder-side downsampling is also provided. The encoder may be configured to receive an input video and generate a downsampling parameter set for the input video. Generating the downsampling parameter set may further include generating an initial parameter set, instantiating a loss function representing a downsampling error rate and an encoding complexity level as a function of a current parameter set based on the initial parameter set and the input video, and selecting a downsampling parameter set that minimizes the loss function.

Selecting the downsampling parameter set may further comprise an iterative process of downsampling at least a portion of the input video using the current parameter set, encoding the downsampled at least a portion of the input video; decoding the encoded at least a portion of the input video; upsampling the decoded at least a portion of the input video; evaluating the loss function as a function of the upsampled at least a portion of the input video, and modifying the current parameter set to minimize the loss function.

The downsampling parameter set can be a parameter set of a neural network, which may be a convolutional neural network. In some embodimenats, the encoder may transmit the downsampling parameter set to a decoder.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating features of the invention, the drawings show aspects of one or more embodiments of systems and methods for practicing the invention. However, it should be understood that the present invention is not limited to the precise arrangements and instrumentalities shown in the drawings, wherein:

FIG. 1 is a block diagram illustrating an exemplary embodiment of a video coding system;

FIG. 2 is a block diagram illustrating an exemplary embodiment of a video coding for machines system;

FIG. 3 is a block diagram illustrating an exemplary embodiment of a system for joint optimization-training;

FIG. 4 is a block diagram illustrating an exemplary embodiment of a system for dual-purpose encoder-side preprocessing;

FIG. 5 is a block diagram illustrating an exemplary embodiment of a system for a training loop;

FIG. 6 is a flow diagram illustrating an exemplary embodiment of a method of dual-purpose encoder-side preprocessing;

FIG. 7 is an exemplary embodiment of a machine learning model for object detection;

FIG. 8 is an exemplary embodiment of a machine learning model for feature extraction;

FIG. 9 is a block diagram of an exemplary embodiment of a machine learning module;

FIG. 10 is a schematic diagram of an exemplary embodiment of a neural network;

FIG. 11 is a schematic diagram of a node of a neural network;

FIG. 12 is an exemplary embodiment of a method for joint optimization training;

FIG. 13 is a block diagram illustrating an exemplary embodiment of a video decoder;

FIG. 14 is a block diagram illustrating an exemplary embodiment of a video encoder; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

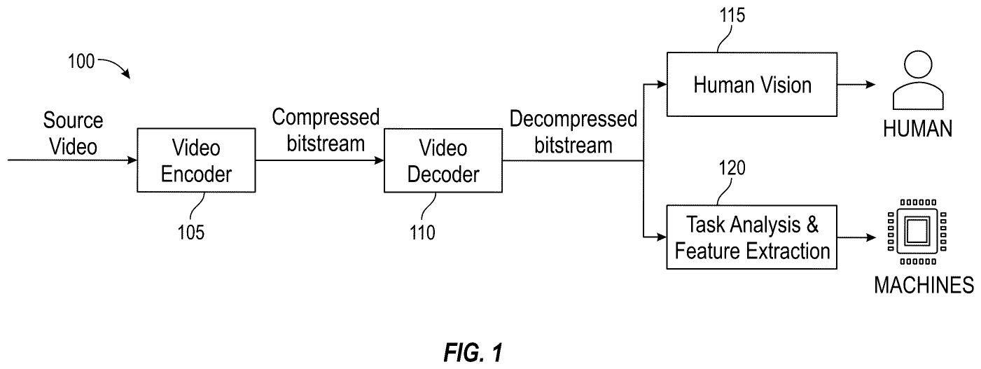

In many applications, such as surveillance systems with multiple cameras, intelligent transportation, smart city applications, and/or intelligent industry applications, traditional video coding may require compression of large number of videos from cameras and transmission through a network to machines and for human consumption. Subsequently, at a machine site, algorithms for feature extraction may applied typically using convolutional neural networks or deep learning techniques including object detection, event action recognition, pose estimation and others. FIG. 1 shows an exemplary embodiment of a standard video encoder 105, such as a Versatile Video Coding (“VVC”) encoder, applied for machines. While VVC is one encoding standard applicable to the present disclosure, it will be appreciated that other encoding standards could be employed. Conventional approaches unfortunately require a massive video transmission from multiple cameras, which may take significant time for efficient and fast real-time analysis and decision-making. In embodiments, a VCM approach may resolve this problem by both encoding video and extracting some features at a transmitter site and then transmitting a resultant encoded bit stream to a VCM decoder. At a decoder site video may be decoded by decoder 110 for human vision 115 and features may be decoded for machines 120.

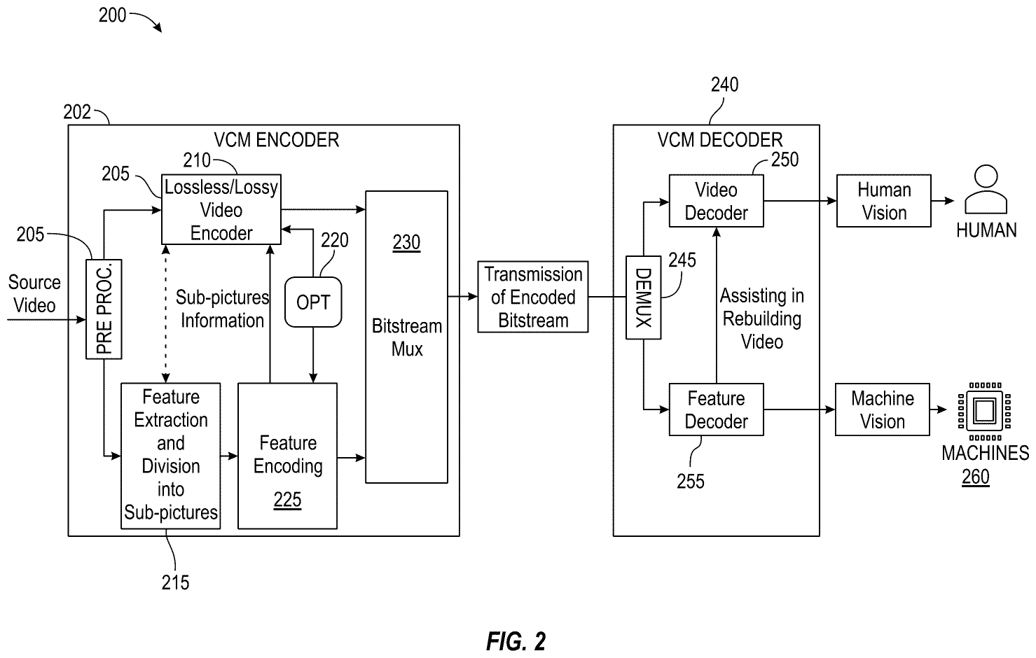

Referring now to FIG. 2, an exemplary embodiment of encoder/decoder for video coding for machines (VCM) is illustrated. VCM encoder may be implemented using any circuitry including without limitation digital and/or analog circuitry. VCM encoder may be configured using hardware configuration, software configuration, firmware configuration, and/or any combination thereof.

VCM encoder may be implemented as a computing device and/or as a component of a computing device, which may include without limitation any computing device as described below. In an embodiment, VCM encoder may be configured to receive an input video and generate an output bitstream. Reception of an input video may be accomplished in any manner described below. A bitstream may include, without limitation, any bitstream as described below.

VCM encoder may include, without limitation, a pre-processor 205, a video encoder 210, a feature extractor 215, an optimizer 220, a feature encoder 225, and/or a multiplexor 230. Pre-processor 205 may receive input video stream and parse out video, audio and metadata sub-streams of the stream. Pre-processor 205 may include and/or communicate with decoder 210 as described in further detail below. In other words, pre-processor 205 may have an ability to decode input streams. This may allow, in a non-limiting example, decoding of an input video, which may facilitate downstream pixel-domain analysis.

Further referring to FIG. 2, VCM encoder may operate in a hybrid mode and/or in a video mode; when in the hybrid mode VCM encoder may be configured to encode a visual signal that is intended for human consumers, to encode a feature signal that is intended for machine consumers; machine consumers may include, without limitation, any devices and/or components, including without limitation computing devices as described in further detail below. Input signal may be passed, for instance when in hybrid mode, through pre-processor.

Still referring to FIG. 2, video encoder may include without limitation any video encoder as described in further detail below. When VCM encoder is in hybrid mode, VCM encoder may send unmodified input video to video encoder 210 and a copy of the same input video, and/or input video that has been modified in some way, to feature extractor 215. Modifications to input video may include any scaling, transforming, or other modification that may occur to persons skilled in the art upon reviewing the entirety of this disclosure. For instance, and without limitation, input video may be resized to a smaller resolution, a certain number of pictures in a sequence of pictures in input video may be discarded, reducing framerate of the input video, color information may be modified, for example and without limitation by converting an RGB video might be converted to a grayscale video, or the like.

Still referring to FIG. 2, video encoder 210 and feature extractor 215 are connected and might exchange useful information in both directions. For example, and without limitation, video encoder 210 may transfer motion estimation information to feature extractor, and vice-versa. Video encoder 210 may provide Quantization mapping and/or data descriptive thereof based on regions of interest (ROI), which video encoder and/or feature extractor may identify, to feature extractor, or vice-versa. Video encoder 210 may provide to feature extractor data describing one or more partitioning decisions based on features present and/or identified in input video, input signal, and/or any frame and/or subframe thereof. Feature extractor 215 may provide to video encoder 210 data describing one or more partitioning decisions based on features present and/or identified in input video, input signal, and/or any frame and/or subframe thereof. Video encoder 210 and feature extractor 215 may share and/or transmit to one another temporal information for optimal group of pictures (GOP) decisions. Each of these techniques and/or processes may be performed, without limitation, as described in further detail below.

With continued reference to FIG. 2, feature extractor 215 may operate in an offline mode or in an online mode. Feature extractor 215 may identify and/or otherwise act on and/or manipulate features. A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor by a remote machine in real time or at some point before extraction.

Still referring to FIG. 2, feature encoder 225 is configured for encoding a feature signal, for instance and without limitation as generated by feature extractor 215. In an embodiment, after extracting the features feature extractor may pass extracted features to feature encoder 225. Feature encoder 225 may use entropy coding and/or similar techniques, for instance and without limitation as described below, to produce a feature stream, which may be passed to multiplexor 230. Video encoder 210 and/or feature encoder 225 may be connected via optimizer 220. Optimizer 220 may exchange useful information between the video encoder 210 and feature encoder 225. For example, and without limitation, information related to codeword construction and/or length for entropy coding may be exchanged and reused, via optimizer 220, for optimal compression.

In an embodiment, and continuing to refer to FIG. 2, video encoder 210 may produce a video stream; video stream may be passed to multiplexor 230. Multiplexor 230 may multiplex video stream with a feature stream generated by feature encoder 225. Alternatively or additionally, video and feature bitstreams may be transmitted over distinct channels, distinct networks, to distinct devices, and/or at distinct times or time intervals (time multiplexing). Each of video stream and feature stream may be implemented in any manner suitable for implementation of any bitstream as described in this disclosure. In an embodiment, multiplexed video stream and feature stream may produce a hybrid bitstream, which may be is transmitted as described in further detail below.

Still referring to FIG. 2, where VCM encoder is in video mode, VCM encoder may use video encoder 210 for both video and feature encoding. Feature extractor 215 may transmit features to video encoder 210; the video encoder 210 may encode features into a video stream that may be decoded by a corresponding video decoder. It should be noted that VCM encoder may use a single video encoder 210 for both video encoding and feature encoding, in which case it may use different set of parameters for video and features; alternatively, VCM encoder may two separate video encoders, which may operate in parallel.

Still referring to FIG. 2, system may include and/or communicate with, a VCM decoder 240. VCM decoder 240 and/or elements thereof may be implemented using any circuitry and/or type of configuration suitable for configuration of VCM encoder as described above. VCM decoder 240 may include, without limitation, a demultiplexor 245. Demultiplexor 245 may operate to demultiplex bitstreams if multiplexed as described above; for instance and without limitation, demultiplexor 245 may separate a multiplexed bitstream containing one or more video bitstreams and one or more feature bitstreams into separate video and feature bitstreams.

Continuing to refer to FIG. 2, VCM decoder may include a video decoder 250. Video decoder 250 may be implemented, without limitation in any manner suitable for a decoder as described in further detail below. In an embodiment, and without limitation, video decoder 250 may generate an output video, which may be viewed by a human or other creature and/or device having visual sensory abilities.

Still referring to FIG. 2, VCM decoder 240 may include a feature decoder. In an embodiment, and without limitation, feature decoder 255 may be configured to provide one or more decoded data to a machine 260. Machine may include, without limitation, any computing device as described below, including without limitation any microcontroller, processor, embedded system, system on a chip, network node, or the like. Machine may operate, store, train, receive input from, produce output for, and/or otherwise interact with a machine model as described in further detail below. Machine may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 2, each of VCM encoder 202 and/or VCM decoder 240 may be designed and/or configured to perform any method, method step, or sequence of method steps in any embodiment described in this disclosure, in any order and with any degree of repetition. For instance, each of VCM encoder 202 and/or VCM decoder 240 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder 202 and/or VCM decoder 240 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

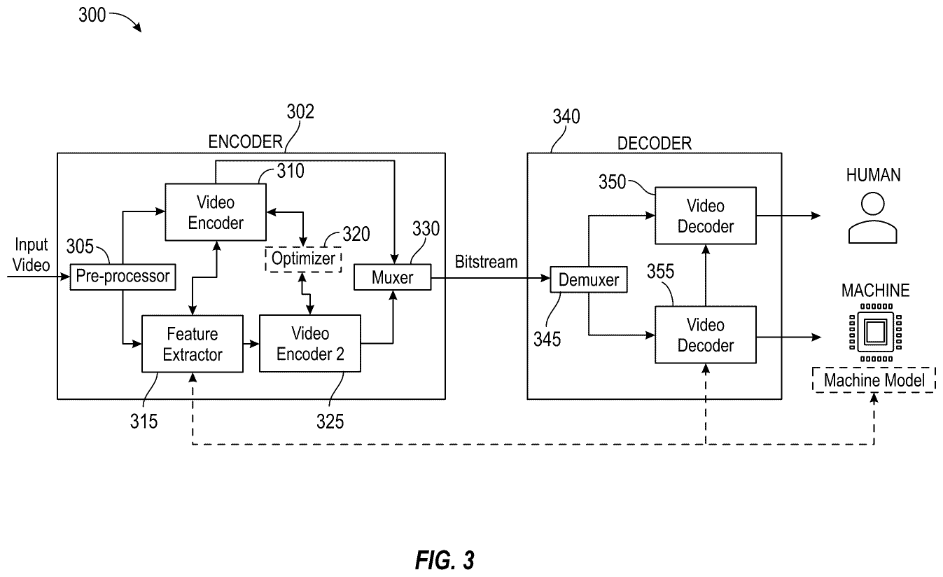

Now referring to FIG. 3, an exemplary embodiment 300 of a system for joint optimization-training for feature video compression is illustrated. In an embodiment, system may include a VCM encoder 302. VCM encoder 302 may include an input video splitter/preprocessor 305. Input video splitter may include a component that converts and/or splits one or more video streams from a camera and/or optical device to video encoder, wherein the conversion may include one or more RGB to YUV conversions, and to a feature extractor. In an embodiment, and without limitation, the stream that is passed to the feature extractor 315 may be converted to one or more alternative and/or appropriate formats. In another embodiment, and without limitation, the stream that is passed to the feature extractor 315 may be quantized and/or down-sampled as a function of a feature extractor requirement. In an embodiment, and without limitation, VCM encoder 302 may include a video encoder 310. Video encoder 310 may include one or more components that compress and/or encode the video stream in a “basic mode” and/or a “feature-compensated mode.” In the “basic mode” video encoder may be operating as a standard video encoder with optional addition of a two-way connection with a feature extractor 315. In an embodiment, and without limitation, this connection may provide additional information that may be used for more efficient compression, such as but not limited to the perceptual domain.

Additionally or alternatively, video encoder 310 may provide useful feedback to the feature extractor, such as but not limited to motion information, scene change information, and the like thereof. In the “feature-compensated mode” the encoder may take both the input video and the feature extractor feedback. In an embodiment, and without limitation, feature maps produced may estimate and encode the residual difference between the maps and the input picture.

Still referring to FIG. 3, VCM encoder 302 may include a feature extractor 315 configured to convert input pixel stream into feature space. In an embodiment, and without limitation, conversion may be done via simple feature extraction (i.e., key-point detection), and/or neural network feature extraction (i.e., filters and/or feature maps) as described below. In an embodiment, and without limitation, input may be provided either by the terminal machine in real-time, and/or from the local storage. Additionally or alternatively, feature extractor 315 may take feedback input from video encoder 310 that optimizes processing. In an embodiment, and without limitation, VCM encoder 302 may include a second video encoder 325 operating as a feature encoder. Feature encoder 325 may include one or more components configured to take extracted features from feature extractor 315 and compresses extracted features as a function of one or more standard lossless and/or lossy techniques that are developed for similar standards, such as but not limited to CDVA. In another embodiment, and without limitation, feature encoder 325 may employ a type of entropy coding. In another embodiment, and without limitation, VCM encoder 302 may include an optimizer 320. Optimizer may include one or more components configured to receive inputs from video encoder 310 and/or feature encoder 325 and signal presence of overlaps and/or redundancies that may be further compressed and/or discarded in video and/or feature bitstreams. In another embodiment, and without limitation, VCM encoder 302 may include a multiplexor or muxer 330. Muxer 330 may include one or more components that combines two or more bitstreams into one bitstream. In another embodiment, and without limitation, VCM encoder 302 may include a machine model copy. In an embodiment, and without limitation, machine model copy may include a copy of the machine model that may be stored on the edge device either independently and/or as a part of an encoder, wherein machine model includes any of the machine model as described below. In another embodiment, and without limitation, machine model copy may allow for both scalable deployment of the configurable encoder software and the offline operational mode when the network connection to the terminal machine is not available.

Still referring to FIG. 3, a system for joint optimization-training for feature video compression may include a VCM decoder 340. VCM decoder 340 may include a demuxer 345. Demuxer 345 may include one or more components that splits input bitstream into video and/or feature bitstreams. In an embodiment, and without limitation, demuxer 345 may operate in an equal and/or opposite function to muxer 330, wherein muxer is described above. In an embodiment and without limitation, VCM decoder 340 may include a second decoder operating as a feature set separator 355. Feature set separator 355 may include one or more components that takes input feature bitstream and separates individual feature sets from the feature bitstream, wherein separating further comprises passing the individual feature sets from the feature bitstream to the feature decoders. In an embodiment, and without limitation, input feature may include one or more relevant features such as features extracted using a relevant technique. In an embodiment, and without limitation, this technique may be a type of machine learning. To obtain optimal results the machine learning model may be trained to produce outputs that are closest to the representation of the input features in the transform space. This allows model to correctly classify, detect, identify or in other ways predict the correct transformation of the relevant features. For example, convolutional neural network (CNN) might be trained to correctly detect and identify human faces in the input images or videos. In an embodiment, and without limitation, VCM decoder may include a feature decoder 355, which may take the form of a video decoder. In an embodiment, and without limitation, feature decoder 355 may include one or more components that decodes individual feature sets received as an input. In another embodiment, and without limitation, feature decoder 355 may send specific subset of features to video decoder as a function of the “feature-compensated mode,” wherein the output may be sent to the terminal machine. In another embodiment, and without limitation, VCM decoder 340 may include a video decoder 350. Video decoder 350 may include one or more standard video decoders, such as, without limitation, AV1, VVC, HEVC and the like. In an embodiment, and without limitation, video decoder may include a “basic mode,” and/or a “feature-compensated mode” as a function of a hybrid decoder. In another embodiment, and without limitation, VCM decoder may include a machine model copy. In an embodiment, and without limitation, machine model copy may include a copy of the machine model that may be stored on the edge device either independently and/or as a part of an encoder, wherein machine model includes any of the machine model as described below.

In standard video coding, input video is passed to an encoder which encodes the video, producing a bitstream. Bitstream is passed to a decoder which through process of decoding produces an output video. A principal goal of video coding may include production of a bitstream that is as small as possible while keeping video quality at a certain level. In this sense it may be possible to qualify input videos as easier or harder to encode. Harder videos may be described as containing content with characteristics that increasing complexity of an encoding and/or decoding process and/or a size of an encoded bitstream. Examples of adverse characteristics with regard to such “harder” videos may include, without limitation, high spatial and/or temporal frequencies in the videos, such as more detailed textures and/or fast motion of large objects within the video. In some embodiments, it may be useful to pre-process a video before encoding, thus producing an input video that is easier to encode. If a pre-processing technique does not produce a visually lossless result, defined as a result in which losses are not visibly discernable for a typical person viewing a resulting video, it may necessary and/or useful to apply an inverse process to pre-processing at a decoder side in the form of post-processing.

In some embodiments, pre- and post-processing techniques may employ machine-learning methods such as convolutional neural networks (CNN) or the like, as described in further detail below. However, problems may arise where a framework in which pre-processing is applied with video coding has not yet been fully integrated with video coding. A pre-processor may be trained independently of an encoder, optimizing only for a utility function of an underlying preprocessing method. For example, a method of down-sampling using a CNN may be optimized for minimum reconstruction error, without regard for spatial frequency complexity of the down-sampled representation. Because of this, an encoder might still require a higher-than-necessary bitrate to represent a down-sampled video. Embodiments described herein present systems and methods for a fully integrated framework for pre-processing and encoding.

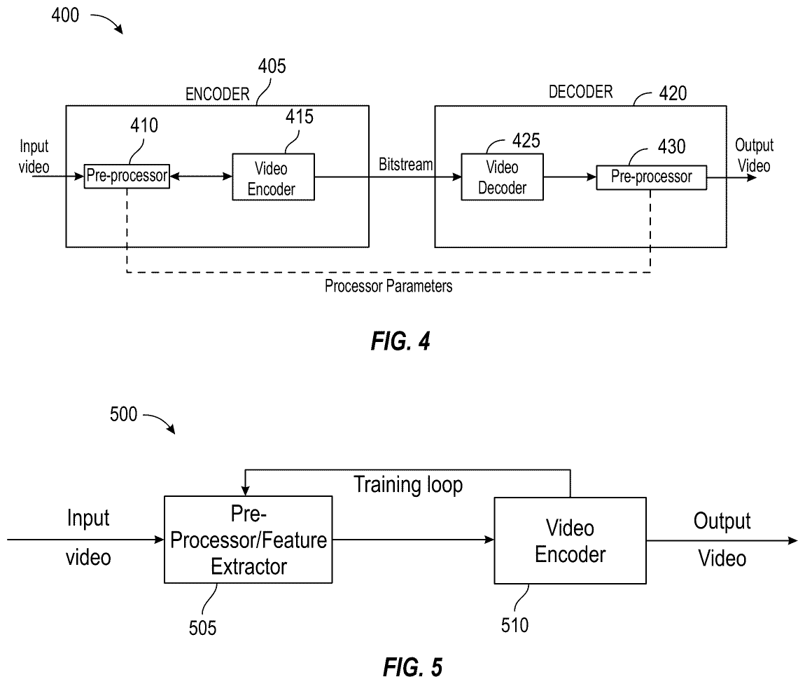

Referring now to FIG. 4, an exemplary embodiment of a proposed framework for integrated pre-processing and encoding is illustrated. In an embodiment, an input video may be passed to a pre-processor 410, which may use a selected method for pre-processing; pre-processor 410 may iterate over different parameters of the pre-processing method in a loop with an encoder. Once optimal parameters are selected, a pre-processed video generated using such parameters may be provided to video encoder 415 and encoded into a bitstream. Bitstream may be sent to a decoder 420. Decoder 420 may include video decoder 425 to decode bitstream, producing a decoded video. Video decoder 425 may pass a decoded video to a post-processor 430, which may apply inverse operation to produce output video. For instance, pre-processor 410 may down-sample an input video to a half-resolution, pass it to encoder 415, which may encode the half-resolution video. Further continuing the example, decoder 420 may receive a bitstream with half-resolution video and decode it. Decoded half-resolution video may then be up sampled to the original resolution. Post-processor 430 may use parameters transmitted thereto by encoder 415 and/or pre-processor 410, for instance in bitstream. Parameters transmitted may be and/or may be based on parameters used for pre-processing. For instance, and without limitation, an optimal set of parameters that is selected by pre-processor may be passed to post-processor, which may use the parameters for an inverse operation. Parameter set may be passed to decoder as a metadata stream that is part of an encoded bitstream, for example and without limitation in a form of a Supplemental Enhancement Information (SEI) metadata message, or as side-information transmitted separately from the bitstream.

Still referring to FIG. 4, parameter set may include any parameters of a machine-learning learning model and/or neural network that can be tuned using machine-learning and/or loss function minimization and/or optimization processes as described in this disclosure. Parameters may include, without limitation, any coefficients, biases, factors, co-factors, terms, constants, or the like.

Now referring to FIG. 5, an exemplary embodiment of an encoder 510 and pre-processor 505, which can be a feature extractor, configuration that may be used for dual-purpose encoder feature representation is illustrated. To produce an optimal bitstream a joint training-optimization loop may be used between pre-processsor/feature extractor 505 and encoder 510. During a training process a model, which may include, without limitation any machine-learning and/or neural network model as described in further detail below, may have parameters trained using a loss function to assign correct parameters to network components. In an embodiment, and without limitation, parameters may include an initial parameter set, wherein an initial parameter set may include one or more parameters that represent a relevant feature such as a human, face, object, and the like thereof. A goal of training process may include production of an output ŷ_{L}, which may be selected and/or intended to be as close as possible to the input yi, for each sample input i. Output ŷ_{L} may be obtained by applying pre-processing, encoding, decoding and/or post-processing, in that order.

Still referring to FIG. 5, to facilitate joint training and optimization, feature extractor's training may be augmented to include a regularization parameter that reflects complexity of encoding for a given representation. This may be done, in a non-limiting example, by augmenting a loss function of the form:

L=Σᵢ l((yᵢ, f(xᵢ, θ))
where L is a loss function that is minimized during a learning process and/or algorithm, [symbol] is a function selected for an appropriate error measure, yi is a value of the target, and f(xi, θ) is an estimated value of a corresponding target; f(xi, θ) may alternatively or additionally be characterized as a hypothesis). Total loss function L may be a sum of errors for all i samples.

Continuing to refer to FIG. 4, and (denoting f(xi, θ) as ŷ_{L}, examples of loss function that may be employed as described above include without limitation
(1) Mean Absolute Error:

$$L = \frac{1}{n} {\sum }_{i = 1}^{n} \vert {y}_{i} - {\hat{y}}_{L} , \vert ;$$

(2) Mean Square Error:

$$L = \frac{1}{n} {\sum }_{i = 1}^{n} {( {y}_{i} - {\hat{y}}_{L} )}^{2} ;$$

and
(3) Cross Entropy: L—(yᵢ log(ŷ_{L})+(1−yᵢ) log(1−ŷ_{L})).

Persons skilled in the art, upon reviewing the entirety of this disclosure, will be aware of various alternative or additional forms of loss functions that may be employed.

Still referring to FIG. 4, an augmented loss function may include a joint-loss function (JLF), defined as a loss function that minimizes feature representation error with a constraint of achieving optimal rate-distortion of a feature stream compressed with a video encoder. A JLF may be of the following form:

$$L R = {\sum }_{i} ℓ ( {y}_{i} , f ( {x}_{i} , θ ) ) + {ρ}_{L} r ( R , D )$$

where r(R,D) is a rate-distortion optimization (RDO) function that is minimized during video encoding. A loss function may be augmented with an addition of regularization term with a parameter ρL, which may be manually tuned and may take any value between 0.0 and 1.0. For example, if it is desired to penalize complexity of a feature representation and emphasize RDO a value of ρL may be set close to 1.0, while if greater emphasis is desired on a precision of feature representation and/or it is desired to minimize an impact of RDO, ρL may be set close to 0.0.

Continuing to refer to FIG. 5, RDO function may take the following form:

r(R, D)=D+λR

where D is a measure of distortion, which may be characterized as a difference between an input and output and/or a compressed picture, R is a measure of bits spent on a compressed bitstream and λ is a Lagrangian operator used for constraint optimization. Examples of a distortion measure may include mean square error (MSE), peak signal-to-noise ratio (PSNR), structural similarity index measure (SSIM), or the like.

Still referring to FIG. 54 to calculate r(R,D) video encoder may employ full encoding or more efficient encoding that approximates a true r(R.D) function. For example, encoder may use further downscaled pictures, a sub-set of pictures, or a combination of both. Encoder may also conduct fast-mode encoding which does not employ all encoding tools. An r(R.D) function may also be approximated with functions that measure input video spatial and temporal complexity without the need for encoding. For example, spatial complexity may be approximated by a variance of pixel values in each coding block. Temporal variance may be approximated by the difference in histograms of pixel values between consecutive frames, or the like.

With continued reference to FIG. 5, once a r(R,D) function is calculated a resulting value may be passed back to pre-processor which may minimize JLF as follows:

$${argmin}_{θ , r} ( ℓ ( {y}_{i} , f ( {x}_{i} , θ ) ) + {ρ}_{L} r ( R , D ) )$$

Further referring to FIG. 5, once the defined threshold for the loss function is achieved a final version of feature maps may be sent to the video encoder. Output bitstream may be then multiplexed with other streams from the VCM encoder, if present, and sent to the end-users.

Still referring to FIG. 5, after a process of training that minimizes JLF, pre-processor may arrive at a set of optimal parameters that may be used to produce input video for video encoder. The same parameters may be passed to a post-processor, for instance at and/or communicating with a decoder, to produce an output video such as without limitation a decoded output video. For example, if a CNN is used for input frame down-sampling, after a process of joint training and encoding, encoder may send a SEI metadata message as a part of bitstream to a decoder of the following form:

| | Descriptor |
|---|---|
| Postprocessing picture parameter SEI message (payloadSize){ | |
| Postprocessing_type | ue(v) |
| Postprocessing_format | u(8) |
| for (i=1; i < payloadSize; i++) { | |
| Postprocessing_parameter_payload_byte | b(8) |
| } | |
| } | |

where Postprocessing_type is a variable describing which type of postprocessing is selected, for instance from a group including simple upscaling, CNN upscaling, Autoencoder, or the like. This variable may be specified in an enumerated list which may contain different types of post-processors, such as upscalers, CNNs, Autoencoders, custom types, or the like.

Still referring to FIG. 5, postprocessing format variable may specify a selected format of a type that is specified in the previous variable. For example, for an upscaler this variable may indicate bilinear, bicubic, Lanczos, or any other pre-defined type of scaling algorithm. Another example, for any type of the Neural network may indicate MPEG NNR, or ONNX (Open Neural Network exchange), and/or NNEF (Neural Network Exchange Format), as non-limiting examples.

Further referring to FIG. 5, once a decoder receives a type and format of postprocessor, for each unit decoder may assign a byte of a payload type of a SEI message specified in Postprocessing_parameter_payload_byte variable. According to a format which is specified by Postprocessing_format, bytes may be decoded, and post-processor parameters may be received. For example, in a case of an upscaler this may include coefficients of a scaling filter, and in case of a neural network this may include weights, hyperparameters or the like of the network.

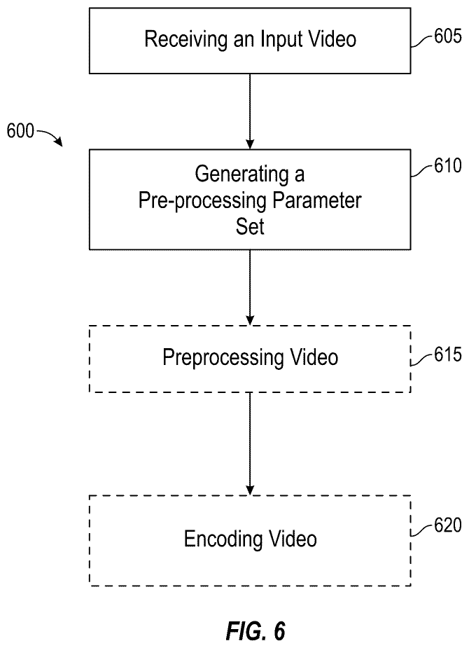

Referring now to FIG. 6, an exemplary method 600 of dual-purpose encoder-side downsampling is illustrated. At step 605, receiving, by an encoder, an input video; this may be accomplished in any manner described in this disclosure. At step 610, and still referring to FIG. 6, encoder generates a pre-processing parameter set, such as a downsampling parameter set, for the input video. This may be accomplished, without limitation, in any manner described above. Downsampling and/or pre-processing parameter set may include a parameter set of a neural network, such as without limitation a convolutional neural network as described above.

Continuing to refer to FIG. 6, generation of pre-processing and/or downsampling parameter set may include generation of an initial parameter set. Initial parameter set may include a “first guess” of parameters; initial parameter set may be selected randomly. Alternatively, initial parameter set may be based on previously generated parameter sets, which may include parameter sets generated during previous performance of methods as described herein for previous input videos, such as parameter sets generated for similar videos and/or types of videos. Parameter sets generated for previous videos may be selected based on use for a video having one or more elements in common with input video. Such parameter sets may be selected to match current input video based on metadata describing the video; for instance, subject and/or contents of each video may be described using one or more keywords. Alternatively or additionally, current input video may be matched to one or more previously processed videos using one or more image and/or video classifiers.

Still referring to FIG. 6, generation of pre-processing and/or downsampling parameter set may include instantiating a loss function representing a downsampling error rate and an encoding complexity level as a function of a current parameter set based on the initial parameter set and the input video, where a “current parameter set” is a parameter set resulting from 0 or more iterations of training and/or tuning processes from the initial parameter set.

With continued reference to FIG. 6, generation may include selecting a downsampling parameter set and/or pre-processing parameter set that minimizes the loss function. In some embodiments, selecting the pre-processing and/or downsampling parameter set may include iteratively performing one or more steps to evaluate loss function and modify current parameter set. For instance, selection may include downsampling and/or pre-processing at least a portion of the input video using the current parameter set. Selection may include encoding the downsampled and/or pre-processed at least a portion; encoded at least a portion may be encoded in a bitstream and/or transmitted to a decoder, which may be incorporated in encoder. Selection may include decoding the encoded at least a portion. Selection may include post-processing and/or upsampling the decoded at least a portion; this may be performed using a post-processor included in and/or communicating with encoder. Selection may include evaluating the loss function as a function of the upsampled at least a portion; evaluation may include comparison of loss function output to a global threshold value representing a desired degree of minimization, comparison of a difference between loss function values from one or more previous iterations and a current loss function value to a threshold representing desired degree of convergence, or any other suitable method. Where a threshold is met, method may exit and cease iterations; alternatively, method may exit after some maximal number of iterations has been performed.

Still referring to FIG. 6, selection may include modifying current parameter set to minimize loss function. This may include, without limitation, modification of one or more parameters by set step amount; for instance, a gradient of a set of parameters may be calculated, and parameters may be modified to decrease parameters in the negative gradient direction. Any other machine-learning and/or tuning process, including any machine-learning and/or tuning process described above, may be used.

Still referring to FIG. 6, encoder may transmit video to an exterior decoder for generation of the video to be viewed by an end-user. For instance, encoder may downsample and/or pre-process 615 input video as a function of the pre-processing and/or downsampling parameter set.

Encoder may encode 620 a bitstream as a function of the downsampled and/or pre-processed video. Encoder may transmit pre-processing and/or downsampling parameter set to a decoder, so that the latter is able to perform corresponding post-processing to a decoded video.

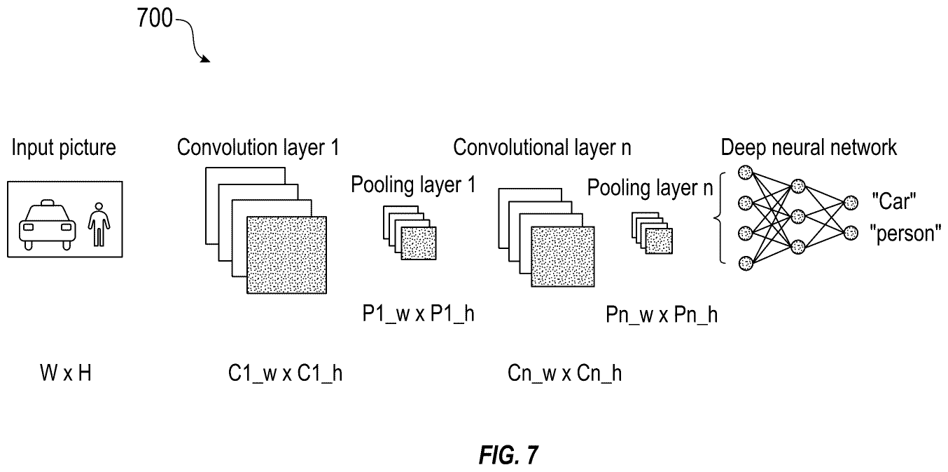

Now referring to FIG. 7, an exemplary embodiment of a machine learning model for object detection is illustrated. In an embodiment, and without limitation model, object detection model may include a convolutional neural network (CNN) and a deep neural network (DNN) which may take a picture as an input and output identification of a car and/or a person if present in the picture. In an embodiment, and without limitation, CNN may transform input image into one or more feature maps using convolution and/or subsequent pooling. In an embodiment, and without limitation, the last pooled layer may be passed as a vector input to DNN. In another embodiment, and without limitation, machine learning model for object detection may use one or more loss functions to assign correct parameters to network components, wherein loss function is described above, in reference to FIGS. 1-6. Additionally or alternatively, machine learning model for object detection may include one or more machine learning models and/or machine-learning process described below.

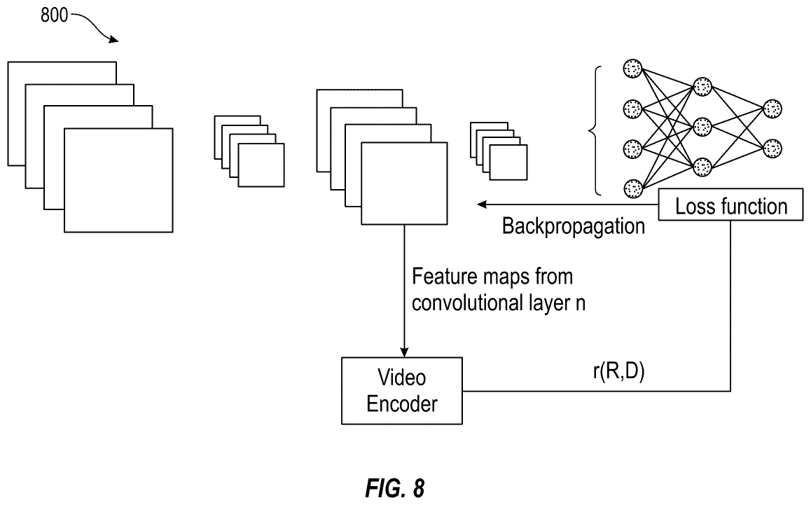

Now referring to FIG. 8, an exemplary embodiment of a machine learning model for feature extraction is illustrated. In an embodiment, and without limitation, machine learning model for feature extraction may be performed in feature extractor, wherein the machine learning model is optimized as a function of the loss function. In an embodiment, and without limitation, machine learning model for feature extraction may be trained offline and/or online, wherein the machine learning model for feature extraction may be implemented in the feature extractor and/or at the end-user interface. In an embodiment, and without limitation, optimized parameters may be sent to the feature extractor for an update. In another embodiment, and without limitation, feature extractor may receive input picture, pass it through the machine learning model for feature extraction such as but not limited to a CNN which produces feature maps at layers which represent different levels of abstraction, and pass a set of maps from the selected layer n to the video encoder. For example, and without limitation, the encoder might use downscaled pictures, sub-set of pictures or combination of both. It may also conduct fast-mode encoding which does not employ all encoding tools. In an embodiment, and without limitation, the subset of pictures or combination of both may be passed to the CNN-DNN network to be included in the overall loss function calculations. The loss function is then used for a process of backpropagation which may calculate optimal values for the model's parameters. In an embodiment, and without limitation, once the defined threshold for the loss function is achieved the process may be completed and the final version of feature maps may be sent to the video encoder. Output bitstream may then be multiplexed with other streams from the VCM encoder, if present, and sent to the end-users. Additionally or alternatively, machine learning model for object detection may include one or more machine learning models and/or machine-learning process described below.

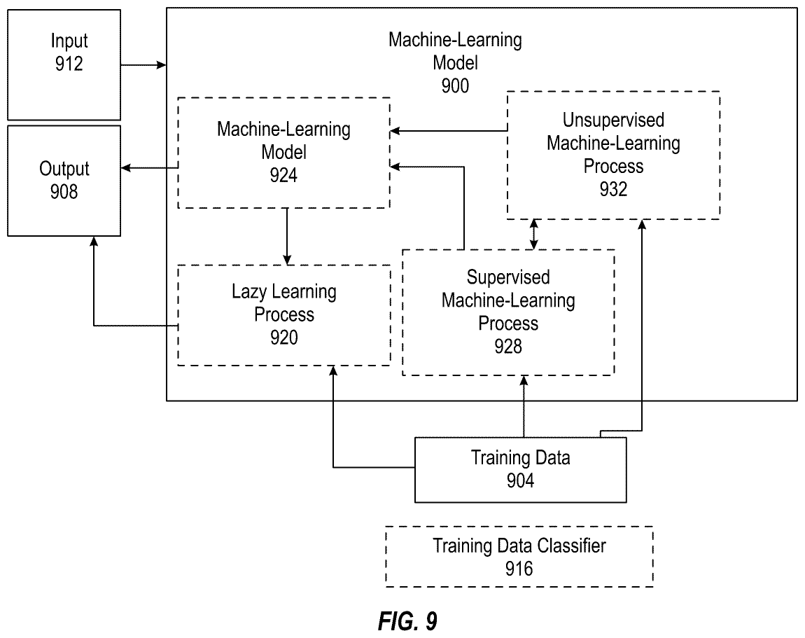

Referring now to FIG. 9, an exemplary embodiment of a machine-learning module 900 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 904 to generate an algorithm that will be performed by a computing device/module to produce outputs 908 given data provided as inputs 912; this is in contrast to a non-machine learning software program where the commands to be executed are determined in advance by a user and written in a programming language.

Still referring to FIG. 9, “training data,” as used herein, is data containing correlations that a machine-learning process may use to model relationships between two or more categories of data elements. For instance, and without limitation, training data 904 may include a plurality of data entries, each entry representing a set of data elements that were recorded, received, and/or generated together; data elements may be correlated by shared existence in a given data entry, by proximity in a given data entry, or the like. Multiple data entries in training data 904 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 704 according to various correlations; correlations may indicate causative and/or predictive links between categories of data elements, which may be modeled as relationships such as mathematical relationships by machine-learning processes as described in further detail below. Training data 704 may be formatted and/or organized by categories of data elements, for instance by associating data elements with one or more descriptors corresponding to categories of data elements. As a non-limiting example, training data 704 may include data entered in standardized forms by persons or processes, such that entry of a given data element in a given field in a form may be mapped to one or more descriptors of categories. Elements in training data 704 may be linked to descriptors of categories by tags, tokens, or other data elements; for instance, and without limitation, training data 704 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 9, training data 904 may include one or more elements that are not categorized; that is, training data 904 may not be formatted or contain descriptors for some elements of data. Machine-learning algorithms and/or other processes may sort training data 904 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 904 to be made applicable for two or more distinct machine-learning algorithms as described in further detail below. Training data 904 used by machine-learning module 900 may correlate any input data as described in this disclosure to any output data as described in this disclosure.

Further referring to FIG. 9, training data may be filtered, sorted, and/or selected using one or more supervised and/or unsupervised machine-learning processes and/or models as described in further detail below; such models may include without limitation a training data classifier 916.

Training data classifier 916 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 900 may generate a classifier using a classification algorithm, defined as a process whereby a computing device and/or any module and/or component operating thereon derives a classifier from training data 704. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 9, machine-learning module 900 may be configured to perform a lazy-learning process 920 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 904. Heuristic may include selecting some number of highest-ranking associations and/or training data 904 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 9, machine-learning processes as described in this disclosure may be used to generate machine-learning models 924. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 924 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 924 may be generated by creating an artificial neural network, such as a convolutional neural network comprising an input layer of nodes, one or more intermediate layers, and an output layer of nodes. Connections between nodes may be created via the process of “training” the network, in which elements from a training data 904 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 9, machine-learning algorithms may include at least a supervised machine-learning process 928. At least a supervised machine-learning process 928, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 904. Persons skilled in the art, upon reviewing the entirety of this disclosure, will be aware of various possible variations of at least a supervised machine-learning process 928 that may be used to determine relation between inputs and outputs. Supervised machine-learning processes may include classification algorithms as defined above.

Further referring to FIG. 9, machine learning processes may include at least an unsupervised machine-learning processes 932. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 9, machine-learning module 900 may be designed and configured to create a machine-learning model 924 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure.

Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 9, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

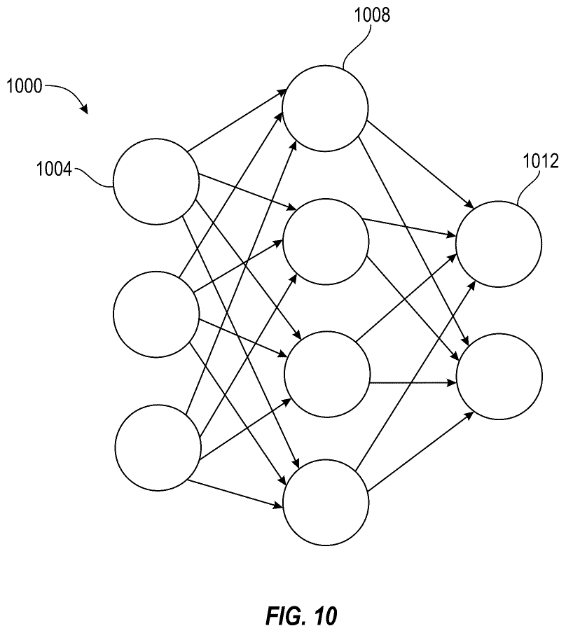

Referring now to FIG. 10, an exemplary embodiment of neural network 1000 is illustrated. A neural network 1000 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.”

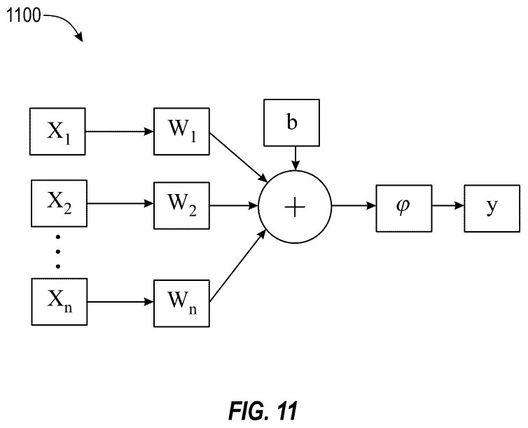

Referring now to FIG. 11, an exemplary embodiment of a node of a neural network is illustrated. A node may include, without limitation a plurality of inputs xi that may receive numerical values from inputs to a neural network containing the node and/or from other nodes.

Node may perform a weighted sum of inputs using weights wi that are multiplied by respective inputs xi. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

Still referring to FIG. 11, a “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

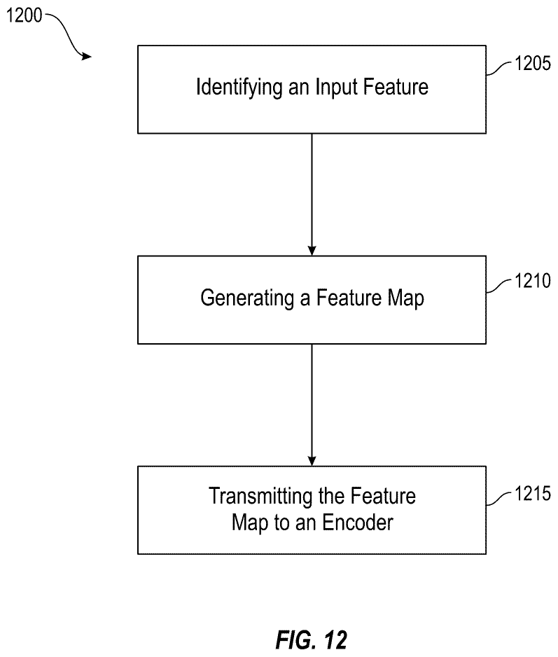

Now referring to FIG. 12, an exemplary embodiment 1200 for a method of joint optimization is illustrated. At step 1205 a feature extractor identifies an input feature. Feature extractor includes any of the feature extractor as described above, in reference to FIGS. 1-11. Input feature includes any of the input feature as described above.

Still referring to FIG. 12, at step 1210, feature extractor generates a feature map for input feature. Feature map includes any of the feature map as described above. Feature extractor generates feature map as a function of receiving an initial parameter set. Initial parameter set includes any of the initial parameter set as described above.

Feature extractor instantiates a loss function representing a feature representation precision and an encoding complexity level as a function of input feature and initial parameter set. Loss function includes any of the loss function as described above or generally known. Feature extractor generates feature map as a function of minimizing loss function.

Still referring to FIG. 12, at step 1215, feature extractor transmits feature map to an encoder. Encoder includes any of the encoder as described above.

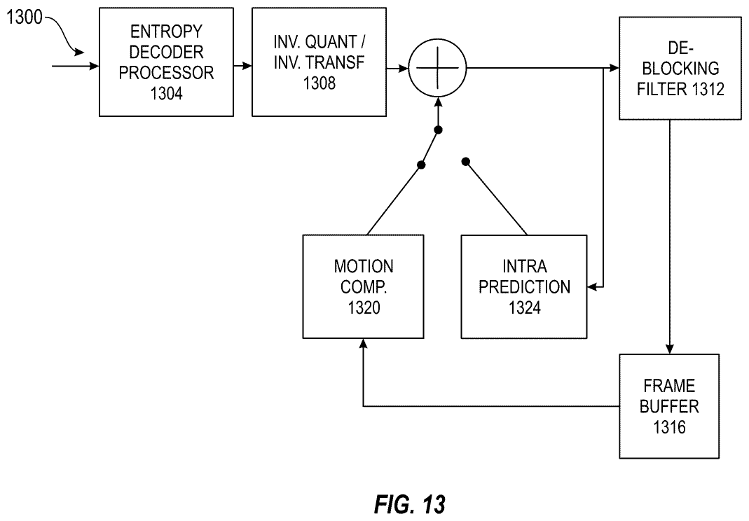

FIG. 13 is a system block diagram illustrating an example decoder. Decoder 1300 may include an entropy decoder processor 1304, an inverse quantization and inverse transformation processor 1308, a deblocking filter 1312, a frame buffer 1316, a motion compensation processor 1320 and/or an intra prediction processor 1324.

In operation, and still referring to FIG. 13, bit stream 1328 may be received by decoder 1300 and input to entropy decoder processor 1304, which may entropy decode portions of bit stream into quantized coefficients. Quantized coefficients may be provided to inverse quantization and inverse transformation processor 1308, which may perform inverse quantization and inverse transformation to create a residual signal, which may be added to an output of motion compensation processor 1320 or intra prediction processor 1324 according to a processing mode. An output of the motion compensation processor 1320 and intra prediction processor 1324 may include a block prediction based on a previously decoded block. A sum of prediction and residual may be processed by deblocking filter 1312 and stored in a frame buffer 1316.

In an embodiment, and still referring to FIG. 13, decoder 1300 may include circuitry configured to implement any operations as described above in any embodiment as described above, in any order and with any degree of repetition. For instance, decoder 1300 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

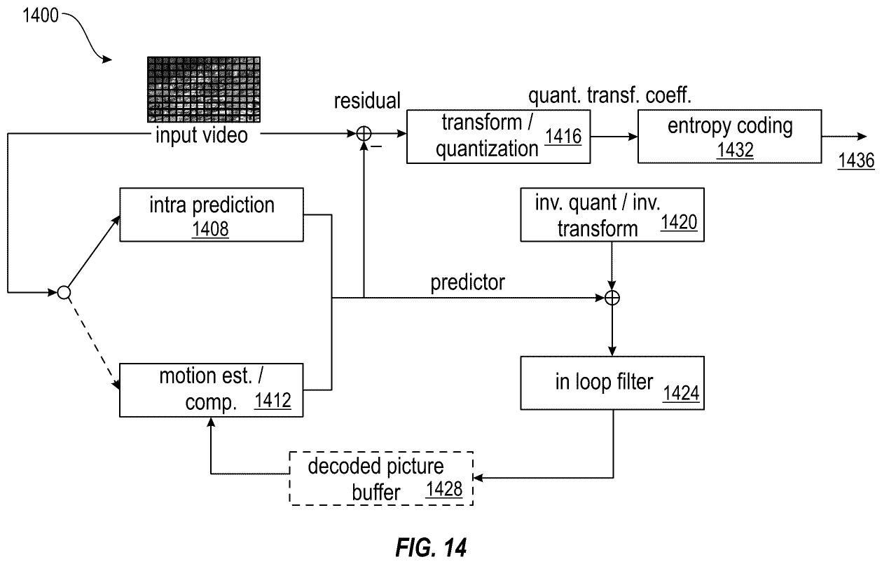

FIG. 14 is a system block diagram illustrating an example video encoder 1400 capable of adaptive cropping. Example video encoder 1400 may receive an input video 1404, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 14, example video encoder 1400 may include an intra prediction processor 1408, a motion estimation/compensation processor 1412, which may also be referred to as an inter prediction processor, capable of constructing a motion vector candidate list including adding a global motion vector candidate to the motion vector candidate list, a transform/quantization processor 1416, an inverse quantization/inverse transform processor 1420, an in-loop filter 1424, a decoded picture buffer 1428, and/or an entropy coding processor 1432. Bit stream parameters may be input to the entropy coding processor 1432 for inclusion in the output bit stream 1436.

In operation, and with continued reference to FIG. 14, for each block of a frame of input video, whether to process block via intra picture prediction or using motion estimation/compensation may be determined. Block may be provided to intra prediction processor 1408 or motion estimation/compensation processor 1412. If block is to be processed via intra prediction, intra prediction processor 1408 may perform processing to output a predictor. If block is to be processed via motion estimation/compensation, motion estimation/compensation processor 1412 may perform processing including constructing a motion vector candidate list including adding a global motion vector candidate to the motion vector candidate list, if applicable.

Further referring to FIG. 14, a residual may be formed by subtracting a predictor from input video. Residual may be received by transform/quantization processor 1416, which may perform transformation processing (e.g., discrete cosine transform (DCT)) to produce coefficients, which may be quantized. Quantized coefficients and any associated signaling information may be provided to entropy coding processor 1432 for entropy encoding and inclusion in output bit stream 1436. Entropy encoding processor 1432 may support encoding of signaling information related to encoding a current block. In addition, quantized coefficients may be provided to inverse quantization/inverse transformation processor 1420, which may reproduce pixels, which may be combined with a predictor and processed by in loop filter 1424, an output of which may be stored in decoded picture buffer 1428 for use by motion estimation/compensation processor 1412 that is capable of constructing a motion vector candidate list including adding a global motion vector candidate to the motion vector candidate list.

With continued reference to FIG. 14, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 14, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 14, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 14, encoder 1400 may include circuitry configured to implement any operations as described above in any embodiment, in any order and with any degree of repetition. For instance, encoder 1400 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 1400 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 14, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 1400 and/or encoder 1400 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

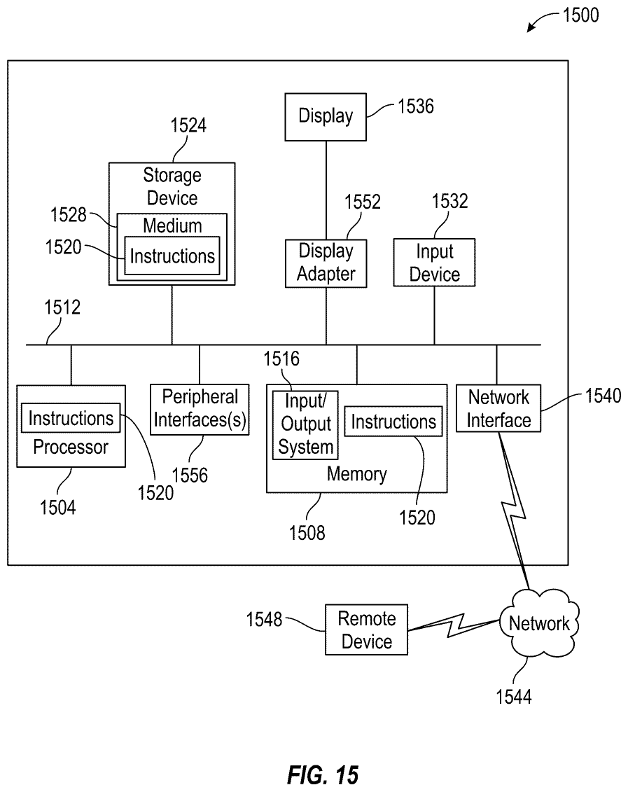

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used.

Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof.

Display adapter 1552 and display device 1536 may be utilized in combination with processor 1304 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of joint optimization-training, the method comprising:
identifying, by a feature extractor, an input feature;
generating, by the feature extractor, a feature map for the input feature, wherein generating the feature map further comprises:
receiving an initial parameter set;
instantiating a loss function representing a feature representation precision and an encoding complexity level as a function of the input feature and the initial parameter set; and
generating the feature map that minimizes the loss function; and
transmitting, by the feature extractor, the feature map to an encoder.

2. The method of claim 1, wherein identifying the input feature further comprises receiving an input video.

3. The method of claim 1, wherein identifying the input feature further comprises determining a relevant feature.

4. The method of claim 3, wherein the determining the relevant feature further comprises: receiving an input training set that correlates a plurality of input features to a plurality of relevant features; and
determine the relevant feature as a function of the input feature using a machine learning model, wherein the machine learning model is trained as a function of the input training set.

5. The method of claim 4, wherein the machine learning model includes a convolutional neural network.

6. The method of claim 4, wherein the machine learning model includes a deep neural network.

7. The method of claim 4, wherein the machine learning model is configured to perform a pooling function.

8. The method of claim 1, wherein the loss function is configured to reduce a bitstream size.

9. The method of claim 1, wherein the loss function is configured to enhance the feature representation precision.

10. The method of claim 1, transmitting the feature map further comprises producing a bitstream as a function of the feature map.

11. A system for joint optimization-training, wherein the system comprises a feature extractor, wherein the feature extractor is configured to:
identify an input feature;
generate a feature map for the input feature, wherein generating the feature map further comprises:
receiving an initial parameter set;
instantiating a loss function representing a feature representation precision and an encoding complexity level as a function of the input feature and the initial parameter set; and
generating the feature map that minimizes the loss function; and transmit the feature map to an encoder.

12. The system of claim 11, wherein identifying the input feature further comprises receiving an input video.

13. The system of claim 11, wherein identifying the input feature further comprises determining a relevant feature.

14. The system of claim 13, wherein the determining the relevant feature further comprises:
receiving an input training set that correlates a plurality of input features to a plurality of relevant features; and
determine the relevant feature as a function of the input feature using a machine learning model, wherein the machine learning model is trained as a function of the input training set.

15. The system of claim 14, wherein the machine learning model includes a convolutional neural network.

16. The system of claim 14, wherein the machine learning model includes a deep neural network.

17. The system of claim 14, wherein the machine learning model is configured to perform a pooling function.

18. The system of claim 11, wherein the loss function is configured to reduce a bitstream size.

19. The system of claim 11, wherein the loss function is configured to enhance the feature representation precision.

20. The system of claim 11, wherein transmitting the feature map further comprises producing a bitstream as a function of the feature map.

21. A method of dual-purpose encoder-side downsampling, the method comprising:
receiving, by an encoder, an input video; and
generating, by the encoder, a downsampling parameter set for the input video, wherein generating the downsampling parameter set further comprises:
generating an initial parameter set;
instantiating a loss function representing a downsampling error rate and an encoding complexity level as a function of a current parameter set based on the initial parameter set and the input video; and
selecting a downsampling parameter set that minimizes the loss function.

22. The method of claim 21, wherein selecting the downsampling parameter set further comprises iteratively:
downsampling at least a portion of the input video using the current parameter set; encoding the downsampled at least a portion;
decoding the encoded at least a portion; upsampling the decoded at least a portion;
evaluating the loss function as a function of the upsampled at least a portion; and modifying the current parameter set to minimize the loss function.

23. The method of claim 21, wherein the downsampling parameter set is a parameter set of a neural network.

24. The method of claim 23, wherein the neural network is a convolutional neural network.

25. The method of claim 21 further comprising downsampling the video as a function of the downsampling parameter set.

26. The method of claim 25 further comprising encoding a bitstream as a function of the downsampled video.

27. The method of claim 21 further comprising transmitting the downsampling parameter set to a decoder.

28. An encoder for dual-purpose encoder-side downsampling, the encoder configured to: receive an input video; and
generate a downsampling parameter set for the input video, wherein generating the downsampling parameter set further comprises:
generating an initial parameter set;
instantiating a loss function representing a downsampling error rate and an encoding complexity level as a function of a current parameter set based on the initial parameter set and the input video; and
selecting a downsampling parameter set that minimizes the loss function.

29. The encoder of claim 28, wherein selecting the downsampling parameter set further comprises iteratively:
downsampling at least a portion of the input video using the current parameter set; encoding the downsampled at least a portion;
decoding the encoded at least a portion; upsampling the decoded at least a portion;
evaluating the loss function as a function of the upsampled at least a portion; and modifying the current parameter set to minimize the loss function.

30. The encoder of claim 28, wherein the downsampling parameter set is a parameter set of a neural network.

31. The encoder of claim 30, wherein the neural network is a convolutional neural network.

32. The encoder of claim 8 further comprising downsampling the video as a function of the downsampling parameter set.

33. The encoder of claim 32 further comprising encoding a bitstream as a function of the downsampled video.

34. The encoder of claim 28 further comprising transmitting the downsampling parameter set to a decoder.

35. A method of dual-purpose encoder-side preprocessing, the method comprising:
receiving, by an encoder, an input video; and
generating, by the encoder, a pre-processing parameter set for the input video, wherein generating the pre-processing parameter set further comprises:
generating an initial parameter set;
instantiating a loss function representing a pre-processing error rate and an encoding complexity level as a function of a current parameter set based on the initial parameter set and the input video; and
selecting a pre-processing parameter set that minimizes the loss function.
